(19) United States
(12) Patent Application Publication
(10) Pub. No.: US 2026/0261942 A1
(43) Pub. Date: Sep. 3, 2026

(54) SYSTEMS AND METHODS FOR SEAMLESS WIRELESS CONNECTIVITY

(71) Applicant: Cable Television Laboratories, Inc., Louisville, CO (US)

(72) Inventors: Lili Hervieu, Buford, GA (US); Irene Macaluso, San Francisco, CA (US)

(21) Appl. No.: 19/554,517

(22) Filed: Mar. 2, 2026

Related U.S. Application Data
(60) Provisional application No. 63/766,208, filed on Mar. 3, 2025.

(51) Int. Cl. H04W 36/18; H04L 41/16; H04W 36/32

(52) U.S. Cl. CPC H04W 36/18; H04L 41/16; H04W 36/32

(57) ABSTRACT

A method for seamless wireless connectivity operable by a user equipment (UE) device includes (i) receiving a roaming model from a machine learning module that is external to the UE device, the roaming model having been trained by the machine learning module at least partially using environmental data that was previously collected by the UE device, (ii) collecting current environmental data, (iii) determining that the UE device is within a decision zone at least partially based on the current environmental data, and (iv) in response to determining that the UE device is within the decision zone, using the roaming model with the current environmental data as an input to the roaming model to make a roaming decision.

### RELATED APPLICATIONS

This application claims benefit of United States Provisional Patent Application Number 63/766,208, filed on March 3, 2025, which is incorporated herein by reference.

### BACKGROUND

A user equipment (UE) device may have two or more wireless communication networks available to serve the UE device at a given time. For example, a UE device may be simultaneously in range of a Wi-Fi wireless communication network and a cellular wireless communication network. UE devices are conventionally configured to select among available wireless communication networks, or among wireless serving devices of a given wireless communication network, based on a Received Signal Strength Indicator (RSSI) and other Layer 1 and Layer 2 wireless KPIs such as SNR, number of retries, and airtime utilization. For example, a UE device may be configured to select an available Wi-Fi wireless communication network over an available cellular wireless communication network if an RSSI of the Wi-Fi wireless communication network is at least a minimum value.

### SUMMARY

In an embodiment, method for seamless wireless connectivity operable by a user equipment (UE) device includes (i) receiving a roaming model from a machine learning module that is external to the UE device, the roaming model having been trained by the machine learning module at least partially using environmental data that was previously collected by the UE device, (ii) collecting current environmental data, (iii) determining that the UE device is within a decision zone at least partially based on the current environmental data, and (iv) in response to determining that the UE device is within the decision zone, using the roaming model with the current environmental data as an input to the roaming model to make a roaming decision.

In another embodiment, a method for seamless wireless connectivity operable by a local controller of a Wi-Fi wireless communication network includes (i) receiving a roaming model from a machine learning module that is external to the local controller, the roaming model having been trained by the machine learning module at least partially using environmental data that was previously collected by a user equipment (UE) device, the UE device being a client of the Wi-Fi wireless communication network, (ii) receiving, from the UE device, current environmental data, (iii) using the roaming model with the current environmental data as an input to the roaming model to make a roaming decision, and (iv) sending the roaming decision to the UE device.

In an additional embodiment, method for seamless wireless connectivity operable by a local controller of a Wi-Fi wireless communication network includes (i) cooperating with a user equipment (UE) device to train a roaming model, the UE device being a client of the Wi-Fi wireless communication network, (ii) receiving, from the UE device, current environmental data, (iii) using the roaming model with the current environmental data as an input to the roaming model to make a roaming decision, and (iv) sending the roaming decision to the UE device.

### BRIEF DESCRIPTION OF THE DRAWINGS

FIG. 1 is a schematic diagram of a communication environment including a Wi-Fi wireless communication network where a user equipment (UE) device moves from a first location to a second location.

FIG. 2 is a schematic diagram of a communication environment including a cellular wireless communication network and a Wi-Fi wireless communication network where a UE device moves between three locations.

FIG. 3 is a schematic diagram of a communication environment including a system for seamless wireless connectivity, according to an embodiment.

FIG. 4 illustrates one example application of a Wi-Fi wireless communication network of the FIG. 3 communication environment.

FIGS. 5A and FIG. 5B are collectively a flowchart of a method for training a roaming model of the FIG. 3 communication environment using on-line reinforcement learning, according to an embodiment.

FIG. 6 is a flowchart of a method for training the roaming model of the FIG. 3 communication environment using off-line reinforcement learning, according to an embodiment.

FIG. 7 is a dataflow diagram illustrating one example of operation of the system for seamless wireless connectivity of FIG. 3.

FIG. 8 is a schematic diagram of an alternative embodiment of the FIG. 3 communication environment where a machine learning module is hosted by a local controller instead of by a distributed computing environment.

FIG. 9 is a dataflow diagram illustrating one example of operation of the system for seamless wireless connectivity of FIG. 8.

FIG. 10 is a schematic diagram of an alternative embodiment of the FIG. 3 communication environment where the roaming model is hosted by a local controller instead of by a UE device.

FIG. 11 is a dataflow diagram illustrating one example of operation of the system for seamless wireless connectivity of FIG. 10.

FIG. 12 is a schematic diagram of an alternative embodiment of the FIG. 3 communication environment where each of a roaming model and a machine learning module is hosted by a local controller.

FIG. 13 is a dataflow diagram illustrating one example of operation of the system for seamless wireless connectivity of FIG. 12.

### DEFINITIONS

The following are definitions of certain terms used in this document:

Wi-Fi wireless communication network: a wireless communication network operating according to an Institute of Electrical and Electronics Engineers (IEEE) 802.11 standard or a successor thereof.

Cellular wireless communication network: a wireless communication network operating according to a Third Generation Partnership (3GPP) standard or a successor thereof.

Wireless serving device: an access point of a Wi-Fi wireless communication network or a base station of a cellular wireless communication network.

User equipment (UE) device: a device capable of being a client of one or more wireless communication networks. For example, a UE device may be capable of being a client of either a Wi-Fi wireless communication network or a cellular wireless communication network. Examples of UE devices include, but are not limited to, mobile phones, computers, set-top devices, data storage devices, Internet of Things (IoT) devices, entertainment devices, computer networking devices, smartwatches, wearable devices with wireless capability, medical devices, security devices, monitoring devices, and wireless access devices.

Roam: an action performed by UE device where the UE device switches from being served by one wireless serving device to being served by another wireless serving device. For example, a UE device may roam from a first access point of a Wi-Fi wireless communication network to a second access point of the Wi-Fi wireless communication network by switching from being served by the first access point to the second access point. As another example, a UE device may roam from a Wi-Fi wireless communication network to a cellular wireless communication network by switching from being served by an access point of the Wi-Fi wireless communication network to a base station of the cellular wireless communication network.

Roaming decision: decision on whether a UE device should roam, e.g., from one wireless communication network to another wireless communication network, or from one wireless serving device of a wireless communication network to another wireless serving device of the wireless communication network.

### DETAILED DESCRIPTION OF THE EMBODIMENTS

As discussed above, user equipment (UE) devices are typically configured to roam among wireless communication networks, or among wireless serving devices of a given wireless communication network, based on a Received Signal Strength Indicator (RSSI). For example, a UE device may be configured to roam from a Wi-Fi wireless communication network to a cellular wireless communication network in response to an RSSI of the Wi-Fi wireless communication network falling below a minimum threshold value. As another example, a UE device may be configured to roam from one access point of a Wi-Fi wireless communication network to another access point of the Wi-Fi wireless communication network in response to an RSSI of a currently serving access point falling below a minimum threshold value. Such conventional triggering of roaming solely on RSSI, though, may result in suboptimal roaming.

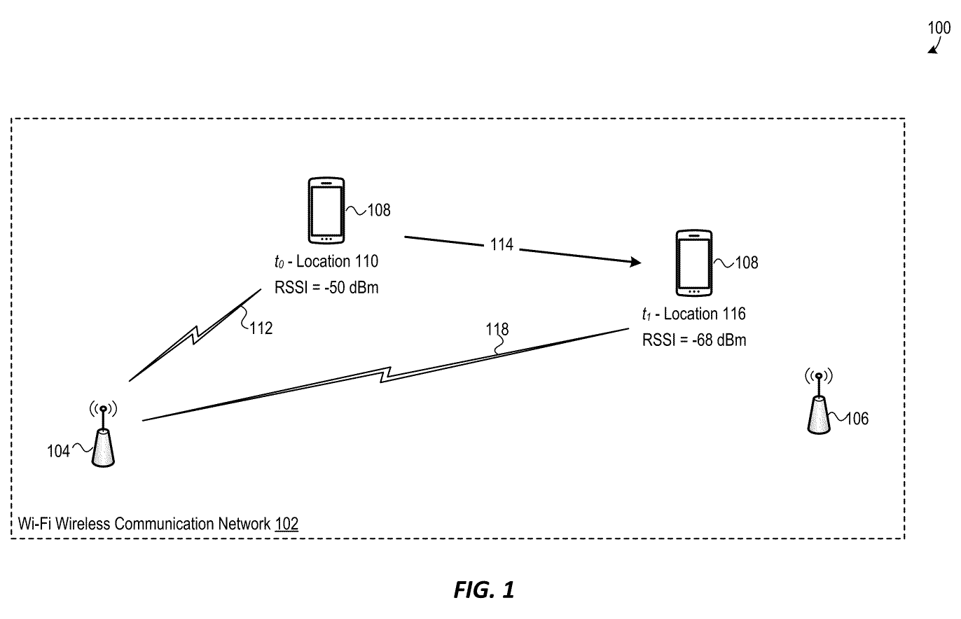

For example, a UE device that is currently connected to a first access point of a Wi-Fi wireless communication network may be undesirably “sticky,” i.e., the UE device may remain connected to the first access point even though it would be better for the UE device to roam to another access point of the Wi-Fi wireless communication network or to a base station of a cellular wireless communication network. For instance, consider FIG. 1 which illustrates a communication environment 100 at two different times. Communication environment 100 includes a Wi-Fi wireless communication network 102, and Wi-Fi wireless communication network 102 includes a first access point 104, a second access point 106, and a UE device 108 in the form of a mobile phone. FIG. 1 assumes that UE device 108 is configured to remain connected to an available access point of a Wi-Fi wireless communication network as long as an RSSI associated with the access point is at least -70 dBm. Stated differently, FIG. 1 assumes that UE device 108 will not attempt to roam from one access point to another access point as long as the RSSI of a currently serving access point is at least -70 dBm.

UE device 108 is at a location 110 at time t 0, where location 110 is relatively close to first access point 104. Accordingly, UE device 108 is served by first access point 104 at time t 0 via a wireless communication link 112 having a high RSSI of -50 dBm. UE device 108 subsequently moves, as indicated by an arrow 114, such that UE device 108 is at a location 116 at a time t 1. Location 116 is relatively far from first access point 104, and UE device 108 is accordingly served by first access point 104 via a wireless communication link 118 having a low RSSI of -68 dBm. Location 116 is closer to second access point 106 than to first access point 104, and UE device 108 would therefore likely be better served by second access point 106 when UE device 108 is at location 116. Nevertheless, UE device 108 remains connected to first access point 104 at location 116 because the RSSI of wireless communication link 118 at location 116, i.e., -68 dBm, is greater than the -70 dBm minimum threshold value to trigger roaming of UE device 108. As such, UE device 108 is undesirable sticky at location 116 in that it remains connected to first access point 104 when it would likely be better served by second access point 106.

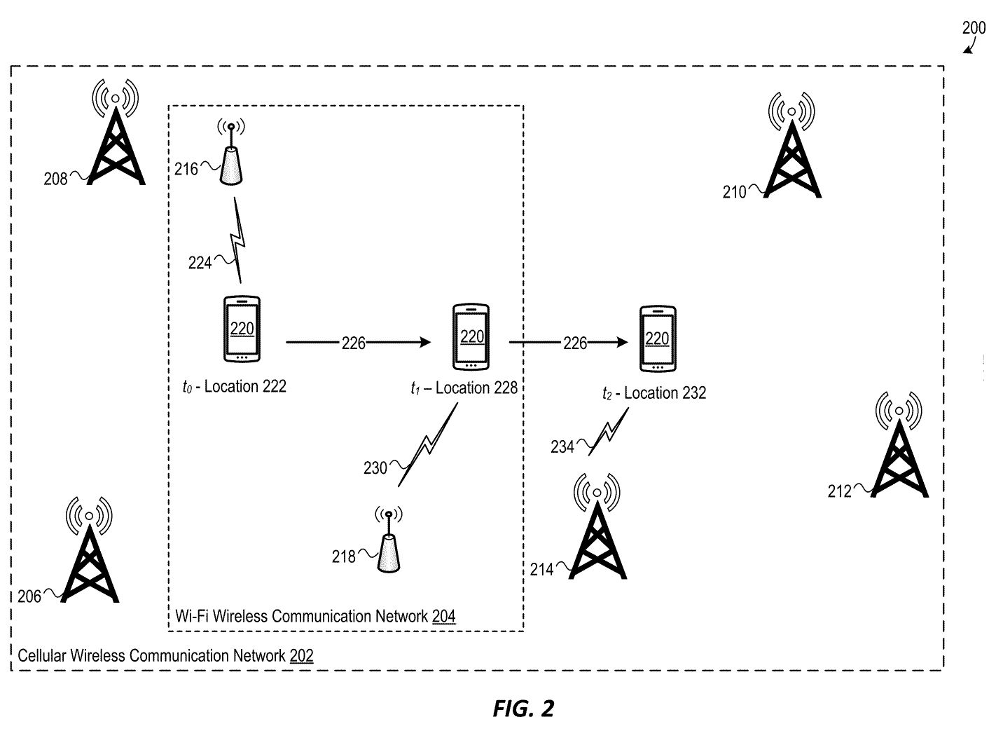

As another example of how triggering roaming solely based on RSSI can result in sub-optimal roaming, consider FIG. 2 which is a schematic diagram of a communication environment 200 including a cellular wireless communication network 202 and a Wi-Fi wireless communication network 204. Cellular wireless communication network 202 includes a base station 206, a base station 208, a base station 210, a base station 212, and a base station 214. Wi-Fi wireless communication network 204 includes an access point 216 and an access point 218. Wi-Fi wireless communication network 204 also initially includes a UE device 220, but as discussed below, UE device 220 leaves Wi-Fi wireless communication network 204 and joins cellular wireless communication network 202 during the time frame depicted in FIG. 2. Wi-Fi wireless communication network 204 is associated with, for example, a home or a business, while cellular wireless communication network 202 serves a large geographic area. Accordingly, Wi-Fi wireless communication network 204 is capable of serving UE devices only within a small area, such as within a home or a business, while cellular wireless communication network 202 is capable of serving UE devices within a service area of Wi-Fi wireless communication network 204 as well as outside of the service area of Wi-Fi wireless communication network 204. As such, a coverage area of Wi-Fi wireless communication network 204 is a subset of a coverage area of cellular wireless communication network 202. FIG. 2 assumes that UE device 220 is configured to remain connected to an available access point of a Wi-Fi wireless communication network as long as an RSSI associated with the access point is at least -70 dBm. Additionally, FIG. 2 assumes that UE device 220 will attempt to connect to an access point of a Wi-Fi wireless communication network, instead of to a base station of a cellular wireless communication network, if an RSSI associated with the access point is at least -70 dBm.

At a time t 0, UE device 220 is at a location 222 which is relatively close to access point 216. Accordingly, UE device 220 is served by access point 216 via a wireless communication link 224. UE device 220 subsequently moves away from access point 216 in a direction illustrated by arrows 226. At a time t 1, UE device 220 is at a location 228, and an RSSI (not shown) of access point 216 at location 228 is below -70 dBm, which triggers UE device 220 to attempt to roam from access point 216 to another available wireless serving device. Both access point 218 and base station 214 have respective RSSIs (not shown) that are greater than – 70 dBm at location 228, and UE device 220 could therefore roam from access point 216 to either of access point 218 or base station 214 at location 228. However, as discussed above, FIG. 2 assumes that UE device 220 is configured to attempt to connect to an available access point of a Wi-Fi wireless communication network instead of a base station of a cellular wireless communication network, when the RSSI of the access point is at least -70 dBm. Consequently, UE device 220 roams from access point 216 to access point 218, instead of roaming from access point 216 to base station 214, and UE device 220 is accordingly served by access point 218 at location 228 via a wireless communication link 230. Importantly, UE device 220 remains at location 228 for only a short period of time before continuing to move in the direction illustrated by arrows 226 to a location 232 at a time t 2. Location 232 is outside of a coverage area of Wi-Fi wireless communication network 204, and UE device 220 accordingly roams to base station 214 of cellular wireless communication network 202 such that UE device 220 is served by base station 214 via a wireless communication link 234.

The roaming depicted in FIG. 2 is sub-optimal in that it includes an unnecessary roaming step. In particular, it was unnecessary for UE device 220 to roam to access point 218 while at location 228 in view of UE device 220 remaining at location 228 for only a short period of time. If UE device 220 had instead roamed to base station 214 while at location 228, one roaming step could have been avoided by eliminating the need for UE device 220 to subsequently roam from access point 218 to base station 214. Minimizing roaming steps is desirable because UE device roaming will typically momentarily interrupt UE connectivity as well as consume UE device resources and wireless communication network resources.

Disclosed herein are new systems and methods for seamless wireless connectivity which at least partially overcome one or more problems associated with conventional UE device roaming. The new systems and methods advantageously consider data in addition to, or in place of, RSSI when making a roaming decision, thereby improving UE device roaming relative to conventional approaches. For example, some embodiments consider UE device location information when making a roaming decision for the UE device. As another example, particular embodiments consider information from one or more external devices that are accessible to a UE device, e.g., data from an Internet of Things (IoT) device accessible to the UE device and/or information from an automobile connected to the UE device, when making a roaming decision for the UE device. As an additional example, certain embodiments consider time and date information when making a roaming decision for a UE device. As a further example, particular embodiments consider information from a calendar accessible to a UE device when making a roaming decision for a UE device. As another example, some embodiments consider user action information when making a roaming decision for a UE device.

Additionally, some embodiments include using a machine learning module to generate a roaming model, and the roaming model is used to make a roaming decision for a UE device. The roaming model could be deployed either within the UE device or external to the UE device, such as in a local controller accessible to the UE device. The machine learning module trains the roaming model, and the UE device optionally provides feedback information to the machine learning module to update the roaming model.

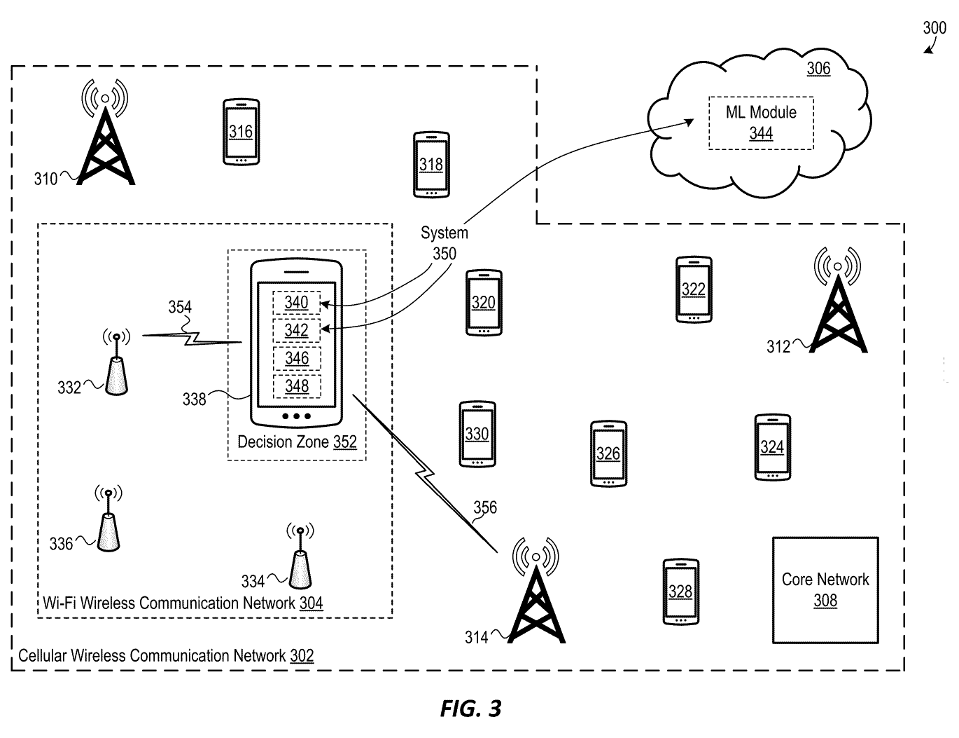

FIG. 3 is a schematic diagram of a communication environment 300 including one embodiment of the new systems for seamless wireless connectivity. Communication environment 300 includes a cellular wireless communication network 302, a Wi-Fi wireless communication network 304, and a distributed computing environment 306. In some embodiments, distributed computing environment 306 is a cloud computing environment, although it is understood that distributed computing environment 306 could be replaced with a different type of computing environment, such as one or more servers at a communication service provider’s facility, without departing from the scope hereof. Cellular wireless communication network 302 includes a core network 308, a base station 310, a base station 312, a base station 314, and UE devices 316-330. The quantity of base stations of cellular wireless communication network 302, as well the quantity of UE devices of cellular wireless communication network 302, may vary. For example, while FIG. 3 depicts cellular wireless communication network 302 as including only three base stations and only eight UE devices due to illustrative space limitations, cellular wireless communication network 302 can, and typically will, include additional base stations and UE devices, such as a large quantity of base stations and UE devices distributed over a large geographic area. Additionally, cellular wireless communication network 302 may include additional elements, such as radio access network (RAN) elements in addition to the depicted base stations. Furthermore, while UE devices 316-330 are depicted as being mobile phones, one or more of UE devices 316-330 could be a different type of UE device, and each UE device in cellular wireless communication network 302 need not be the same type of UE device.

Wi-Fi wireless communication network 304 includes an access point 332, an access point 334, an access point 336, and a UE device 338. The quantity of access points in Wi-Fi wireless communication network 304 may vary. For example, Wi-Fi wireless communication network 304 may alternately include only a single access point, or Wi-Fi wireless communication network 304 may include one or more additional access points. Additionally, while FIG. 3 illustrates Wi-Fi wireless communication network 304 as including only a single UE device, i.e., UE device 338, Wi-Fi wireless communication network 304 may include additional UE devices. Although UE device 338 is depicted as being a mobile phone, it is understood that UE device 338 could be a different type of UE device. UE device 338 is a client of Wi-Fi wireless communication network 304, and UE device 338 supports both cellular wireless communication and Wi-Fi wireless communication.

Wi-Fi wireless communication network 304 is a local area network (LAN) associated with, for example, a home or a business, while cellular wireless communication network 302 serves a large geographic area. Accordingly, Wi-Fi wireless communication network 304 is capable of serving UE devices only within a small area, such as within a home or business, while cellular wireless communication network 302 is capable of serving UE devices over a large area, including within a coverage area of Wi-Fi wireless communication network 304. As such, the coverage area of Wi-Fi wireless communication network 304 is a subset of a coverage area of cellular wireless communication network 302.

UE device 338 hosts a collection application 340 and roaming model 342, and distributed computing environment 306 hosts a machine learning (ML) module 344. FIG. 3 also depicts UE device 338 as storing environmental data 346 and a roaming decision 348. In some embodiments, each of collection application 340 and roaming model 342 is embodied by respective instructions (not shown), such as instructions in the form of software and/or firmware, stored in a storage element (not shown) of UE device 338, and the instructions are executed by a processor (not shown) of UE device 338 to perform the functions of collection application 340 and roaming model 342. Similarly, in some embodiments, machine learning module 344 is embodied by instructions (not shown), such as instructions in the form of software and/or firmware, stored in a storage element (not shown) of distributed computing environment 306, and the instructions are executed by a processor (not shown) of distributed computing environment 306 to perform the functions of machine learning module 344.

Collection application 340, roaming model 342, and machine learning module 344 collectively implement a system 350, where system 350 is one embodiment of the new systems for seamless wireless connectivity. Roaming model 342 is configured to make a roaming decision 348 for UE device 338 when UE device 338 is within a decision zone 352. In certain embodiments, roaming model 342 is configured to make a roaming decision by (i) determining an anticipated future location of UE device 338, (ii) determining whether roaming is desirable based on the anticipated future location of UE device 338, and (ii) if roaming is desirable, identifying a roaming target, i.e., a wireless communication network and/or a specific wireless serving device, for UE device 338 to roam to. Machine learning module 344 is configured to train roaming model 342 at least partially based on environmental data 346 collected by collection application 340. Decision zone 352 could be any location where it is desired to make a roaming decision for UE device 338, although it is anticipated that decision zone 352 will typically be a location where presence of UE device 338 at the location indicates that it may soon be necessary for UE device 338 to roam. For example, decision zone 352 could be located near an exterior door of a building such that presence of UE device 338 in decision zone 352 may mean that UE device 338 will soon exit the building and therefore need to roam from a wireless serving device within the building to a wireless serving device outside of the building. As another example, decision zone 352 could be located at the base of a staircase or an elevator such that presence of UE device 338 in decision zone 352 may indicate that UE device 338 will soon move to a different floor of a building and therefore need to roam from a wireless serving device on one floor of the building to a wireless serving device on another floor of the building.

While decision zone 352 is depicted as a two-dimensional rectangular area, decision zone 352 could have other forms without departing from the scope hereof. For example, decision zone 352 could be a three-dimensional volume, or decision zone 352 could be a one dimensional line. As another example, decision zone 352 could be square, circular, or irregular shaped, instead of being rectangular shaped. As a further example, decision zone 352 could be defined by one or more attributes in addition to location. For example, decision zone 352 could be a three-dimensional volume that is further defined by time of day, e.g., decision zone 352 could be defined so that UE device 338 must be within a predetermined geographic volume within a particular time range for UE device 338 to be considered within decision zone 352, such that decision zone 352 is effectively a four-dimensional zone.

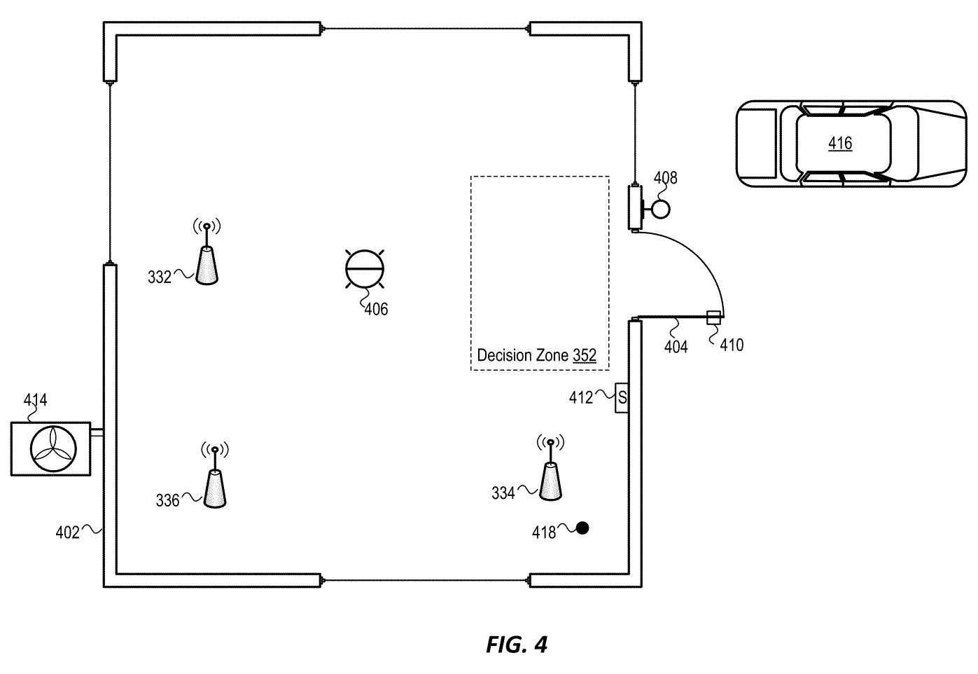

Environmental data 346 is data representing an operating environment of UE device 338. Machine learning module 344 uses environmental data 346 to train roaming model 342. Additionally, roaming model 342 uses environmental data 346 as an input when making a roaming decision 348. Environmental data 346 includes, for example, data that may be used to (i) predict a future location of UE device 338 and/or (ii) predict a best wireless serving device for serving UE device 338 in view of its predicted future location. In some embodiments, environmental data 346 includes one or more of the following example types of data. However, it is understood that environment data 346 is not limited to the examples below. Additionally, while some of the examples below refer to an example application of Wi-Fi wireless communication network 304 in a building depicted in FIG. 4, it is understood that the examples below are not limited to the FIG. 4 example application.

Environmental Data Example A – Location Information. In some embodiments, environmental data 346 includes location information representing location of UE device 338. Collection application 340 may obtain location information, for example, from global position system (GPS) data collected by UE device 338, IEEE 802.11az Next Generation Positioning (NGP) data from Wi-Fi wireless communication network 304, and/or a combination of RSSI and additional physical (PHY) layer information, such as a combination of RSSI and channel state information, from Wi-Fi wireless communication network 304. In some embodiments, collection application 340 and/or machine learning module 344 track location information collected by collection application 340 as a function of time. Machine learning module 344 may use historic location information to help train roaming model 342 to predict a future location of UE device 338. Additionally, roaming model 342 may use current location information collected by collection application 340 as an input when making roaming decision 348.

Environmental Data Example B – Cellular Wireless Communication Information. In some embodiments, environmental data 346 includes information representing cellular wireless communication network 302, such as availability of cellular wireless communication network 302, signal characteristics of cellular wireless communication network 302 (e.g., reference signal received power (RSRP) and/or reference signal received quality (RSRQ)), and/or identify of base stations of cellular wireless communication network 302. In some embodiments, collection application 340 and/or machine learning module 344 track cellular wireless communication information as function of location of UE device 338. Machine learning module 344 may use historic cellular communication information collected by collection application 340, for example, to train roaming model 342 to predict a best wireless communication network and/or a best wireless serving device to serve UE device 338 in view of its predicted future location.

Environmental Data Example C – Wi-Fi Wireless Communication Information. In some embodiments, environmental data 346 includes information representing Wi-Fi wireless communication network 304, such as respective capabilities of access points 332, 334, and 336, RSSI of one or more access points 332, 334, and 336, and/or channel states of one or more access points 332, 334, and 336. In some embodiments, collection application 340 and/or machine learning module 344 track Wi-Fi wireless communication information as function of location of UE device 338. Machine learning module 344 may use historic Wi-Fi communication information collected by collection application 340, for example, to train roaming model 342 to predict a best wireless communication network and/or a best wireless serving device to serve UE device 338 in view of its predicted future location. It should be noted that Wi-Fi wireless communication information collected by collection application 340 may be limited to a single band, e.g., a 2.4 GHz band, a 5 GHz band, or a 6 GHz band, or the Wi-Fi wireless communication information may span two or more bands, e.g., two or more of a 2.4 GHz band, a 5 GHz band, and a 6 GHz band.

Environmental Data Example D – Time and Date Information. In some embodiments, environmental data 346 includes time and date information. In some embodiments, collection application 340 and/or machine learning module 344 use historic time information and/or historic date information collected by collection application 340 to track other environmental data, such as to track location of UE device 338 as a function of time and/or as a function of date. Additionally, roaming model 342 may use current time information and/or current date information collected by collection application 340 as an input when making roaming decision 348.

Environmental Data Example E – Calendar Information. In some embodiments, environmental data 346 includes calendar information, such as from a calendar associated with a user of UE device 338. Machine learning module 344 may use calendar information collected by collection application 340 to help train roaming model 342 to predict a future location of UE device 338. Additionally, roaming model 342 may use calendar information collected by collection application 340 as an input when making roaming decision 348.

Environmental Data Example F – User Action Information. In some embodiments, environmental data 346 includes user action information, such as a report of a user enabling or disabling Wi-Fi communication on UE device 338, or a report of a user enabling or disabling cellular communication on UE device 338. Machine learning module 344 may use user action information collected by collection application 340 to help train roaming model 342 to predict a future location of UE device 338. Additionally, roaming model 342 may use user action information collected by collection application 340 as an input when making roaming decision 348.

Environmental Data Example G – Information from an External Device. In some embodiments, environmental data 346 includes information from one or more devices that are external to UE device 338, such as data from IoT devices and/or automobiles. For example, consider FIG. 4, which illustrates an application of Wi-Fi wireless communication network 304 in a building 402. Each access point 332, 334, and 336 is located within building 402, and decision zone 352 is located near an exterior door 404 of building 402. FIG. 4 additionally depicts a smart light 406 within building 402, a smart light 408 on the exterior of building 402, a smart lock 410 on exterior door 404, a security system 412 within building 402, a smart heating, ventilation, and air conditioning (HVAC) unit 414 outside of building 402, and an automobile 416 outside of building 402. Examples of environmental data 346 that some embodiments collect in the FIG. 4 example include, but are not limited to, state of smart light 406 (e.g., on or off), state of smart light 408 (e.g., on or off), state of smart lock 410 (e.g., locked or unlocked), state of security system 412 (e.g., armed or disarmed), state of smart HVAC unit 414 (e.g., operating in a home mode or an away mode), and state of automobile 416 (e.g., connected to UE device 338, operating in a remote start mode, locked, unlocked, etc.). Applicant has found that this environmental data may be used to predict a future location of UE device 338.

For example, change of interior smart light 406 state from on to off when UE device 338 is within decision zone 352 may indicate that UE device 338 is likely to leave building 402, especially if paired with change of exterior smart light 408 state from off to on. As another example, change of interior smart light 406 state from off to on when UE device 338 is within decision zone 352 may indicate that UE device 338 is likely to remain with building 402, especially if paired with exterior smart light 408 remaining in off state. As an additional example, change of smart lock 410 state from locked to unlocked while UE device 338 is within decision zone 352 may indicate that UE device 338 is likely to leave building 402, while smart lock 410 remaining in locked state while UE device 338 is within decision zone 352 may indicate that UE device 338 is likely to remain within building 402.

As a further example, change of security system 412 state from disarmed to armed while UE device 338 is within decision zone 352 may indicate that UE device 338 is likely to leave building 402, while security system 412 remaining in disarmed state while UE device 338 is within decision zone 352 may indicate that UE device 338 is likely to remain within building 402. As another example, operation of smart HVAC unit 414 in away mode when UE device 338 is within decision zone 352 may indicate that UE device 338 is likely to leave building 402. Conversely, operation of smart HVAC unit 414 in home mode when UE device 338 is within decision zone 352 may indicate that UE device 338 is likely to remain with building 402.

As an additional example, any one of (i) UE device 338 being connected to automobile 416, (ii) automobile 416 switching from a locked state to an unlocked state, and (iii) automobile 416 operating in a remote start mode, while UE device 338 is within decision zone 352 may indicate that UE device 338 is likely to leaving building 402. On the other hand, UE device 338 being disconnected from automobile 416 while UE device 338 is within decision zone 352 may indicate that UE device 338 is likely to remain within building 402.

Accordingly, in certain embodiments, machine learning module 344 uses historic data from one or more external devices to help train roaming model 342 to predict a future location of UE device 338. Additionally, in some embodiments, roaming model 342 uses current data from one or more external devices as an input when making roaming decision 348. It should be noted that environmental data 346 could include data from an external device different from, or in addition to, the data discussed above with respect to FIG. 4. Examples of additional or alternative environmental data from an external device include, but are not limited to, state of a smart garage door opener, state of a security camera, state of a motion sensor, state of a smart television or other entertainment device, state of a computer or other information technology (IT) device, state of a smart appliance, state of a smart thermostat, etc.

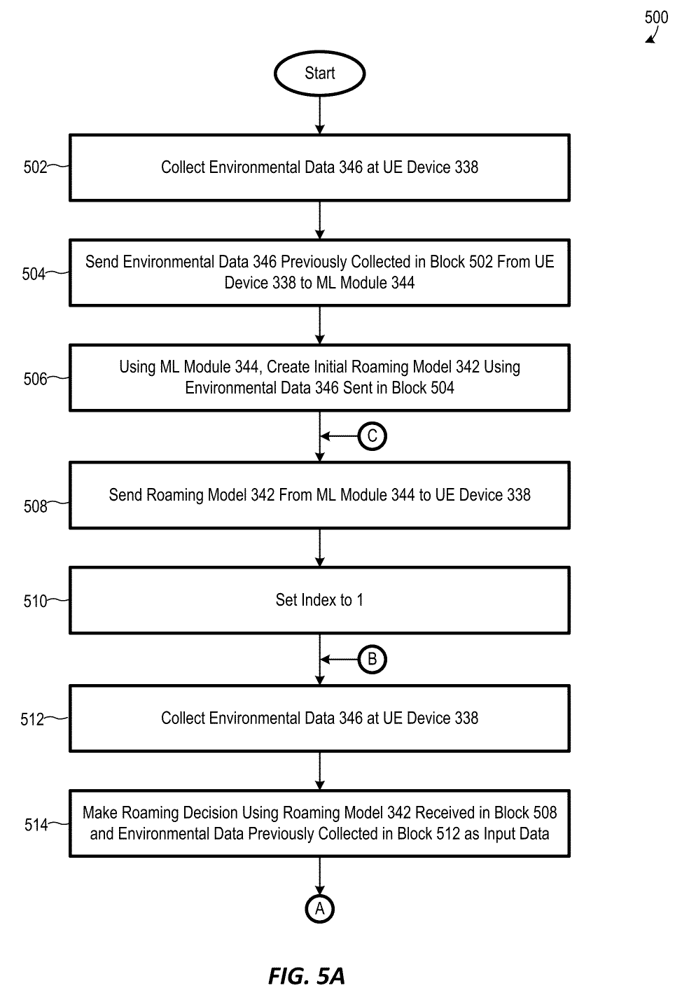

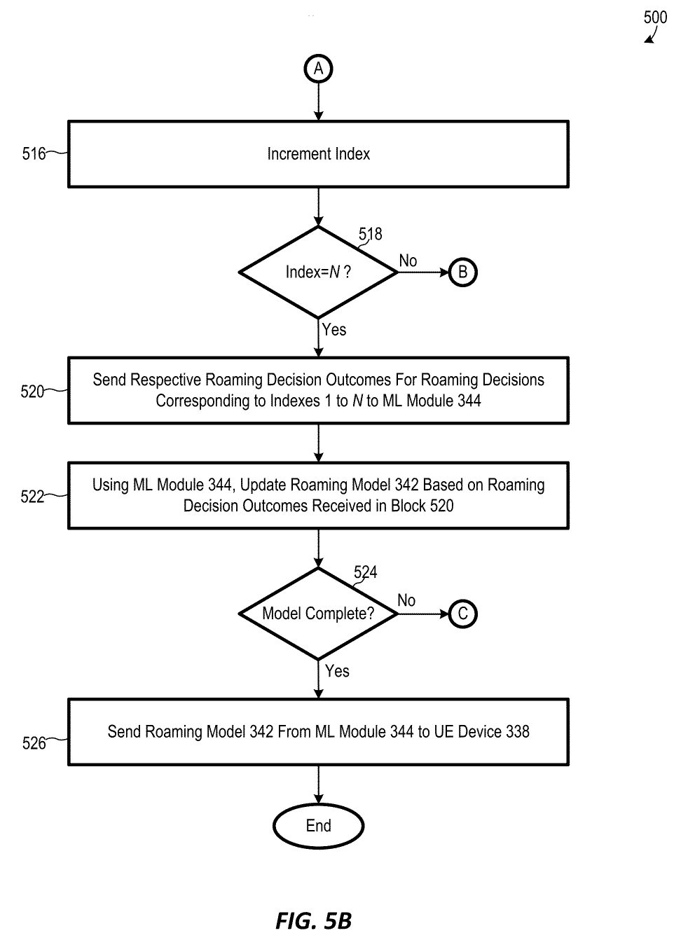

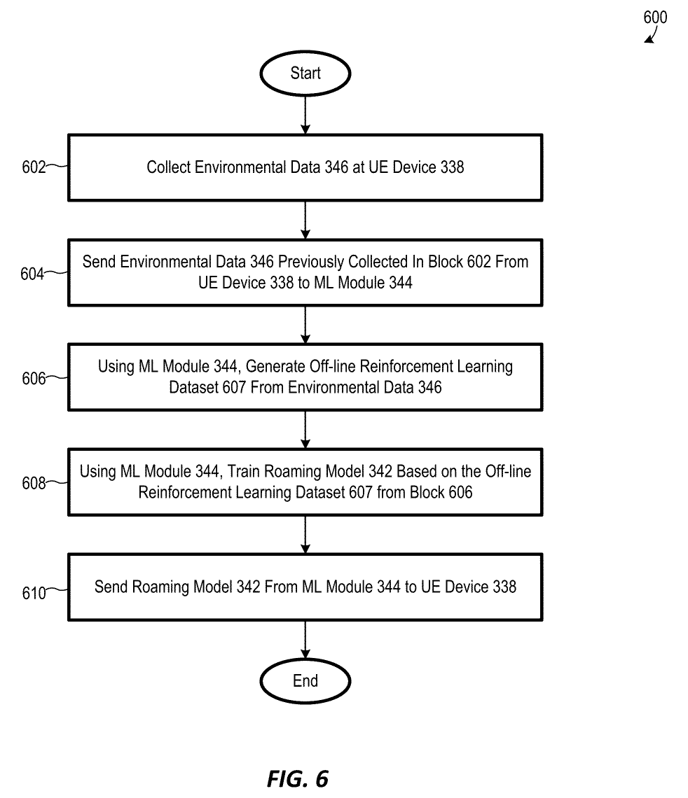

Referring again to FIG. 3, machine learning module 344 may use any suitable machine learning technique to train roaming model 342. Discussed below with respect to FIGS. 5A, 5B, and 6 are two examples of machine learning module 344 using reinforcement learning to train roaming model 342. However, machine learning module 344 is not limited to using reinforcement learning. Additionally, in embodiments where machine learning module 344 uses reinforcement learning, it is not limited to operating according to the examples of FIGS. 5A, 5B, and 6.

FIGS. 5A and FIG. 5B are collectively a flowchart of a method 500 for training roaming model 342 using on-line reinforcement learning. In a block 502 of method 500, collection application 340 on UE device 338 collects environmental data 346. Method 500 proceeds from block 502 to a block 504 where UE device 338 sends the environmental data 346 previously collected in block 502 to machine learning module 344. Method 500 then proceeds from block 504 to a block 506 where machine learning module 344 creates an initial roaming model 342 based on the environmental data 346 sent in block 504. Machine learning module 344 creates the initial roaming model 342, for example, by (i) constructing a roaming model with inputs for each type of environmental data sent in block 504 and (ii) configuring roaming model 342 to generate a random roaming decision 348 in response to the environmental data 346 sent in block 504. For instance, assume that environmental data 346 sent in block 504 includes the following data: (i) location=a, (ii) time=b, (iii) smart light state=c, and (iv) smart lock state=d. In this scenario, machine learning module 344 would create roaming model 342 having the following inputs: (i) location, (ii) time, (iii) smart light state, and (iv) smart lock state. At this stage, machine learning module 344 would not know the correct roaming decision of roaming model 342, e.g., either remain served by Wi-Fi wireless communication network 304 or roam to cellular wireless communication network 302, in response to input vector [a, b, c, d], and machine learning module 344 would therefore randomly select a roaming decision for roaming model 342 to make in response to this input vector.

Method 500 proceeds from block 506 to a block 508 where machine learning module 344 sends the initial roaming model 342 to UE device 338, and method 500 proceeds from block 508 to a block 510 where UE device 338 sets an index to one. Method 500 proceeds from block 510 to a block 512 where collection application 340 collects additional environmental data 346 at UE device 338. Method 500 proceeds from block 512 to a block 514 where UE device 338 makes a roaming decision using the roaming model 342 received in block 508 with environmental data 346 previously collected in block 512 as input data to roaming model 342. Method 500 proceeds from block 514 to a block 516 where UE device 338 increments the index, and method 500 then proceeds to a decision block 518 which determines whether the index is equal to N. N is a positive integer that is equal to a desired number of roaming decisions 348 to be made before roaming model 342 is updated. For example, if N is equal to 3, roaming model 342 makes three roaming decisions 348 before roaming model 342 is updated. If the result of decision block 518 is no, method 500 returns to block 512 where additional environmental data 346 is collected. If the result of decision block 518 is yes, method 500 proceeds to a block 520.

In block 520, UE device 338 sends respective roaming decision outcomes corresponding to roaming indexes 1 to N to machine learning module 344, where each roaming decision outcome represents whether its respective roaming decision 348 was successful. UE device 338 determines that a given roaming decision 348 was successful, for example, if one or more communication metrics for UE device 338 meet predetermined requirements after implementation of the roaming decision 348. For example, in some embodiments, UE device 338 determines that a given roaming decision 348 was successful in response to UE device 338 not losing communication service in response to implementing the roaming decision 348. As another example, in certain embodiments, UE device 338 determines that a given roaming decision 348 was successful in response to communication bandwidth available to UE device 338 not dropping below a predetermined minimum value in response to implementing the roaming decision 348. Method 500 proceeds from block 520 to a block 522 where machine learning module 344 updates roaming model 342 based on roaming decision outcomes received in block 520. For example, if a given roaming decision was successful, machine learning module 344 may update roaming model 342 to reinforce rules of roaming model 342 which produced the successful roaming decision. As another example, if a given roaming decision was unsuccessful, machine learning module 344 may update roaming model 342 to change rules of roaming model 342 which produced the unsuccessful roaming decision.

Method 500 proceeds from block 522 to a decision block 524 where machine learning module 344 determines whether roaming model 342 is complete. For example, in some embodiments, machine learning module 344 determines that roaming model 342 is complete after block 522 has been executed a predetermined number of times. As another example, in certain embodiments, machine learning module 344 determines that roaming model 342 is complete in response to at least a predetermined percentage of K most recently received outcomes being positive, where K is positive integer, such as 100, 500, or 1,000. If the result of decision block 524 is no, method 500 returns to block 508 where machine learning module 344 sends roaming model 342, as updated in block 522, to UE device 338 for use in making subsequent roaming decisions. If the result of decision block 524 is yes, method 500 proceeds to a block 526 where machine learning module 344 sends roaming model 342, as updated in block 522, to UE device 338 as a final roaming model 342.

FIG. 6 is a flowchart of a method 600 for training roaming model 342 using off-line reinforcement learning. In a block 602 of method 600, collection application 340 on UE device 338 collects environmental data 346, such as environmental data spanning a significant amount of time. Method 600 proceeds from block 602 to a block 604 where UE device 338 sends the environmental data 346 previously collected in block 602 to machine learning module 344. Method 600 then proceeds from block 604 to a block 606 where machine learning module 344 generates an off-line reinforcement learning dataset 607 from environmental data 346 sent in block 604. In some embodiments, off-line reinforcement learning dataset 607 includes the following data: (i) states, (ii) actions, (iii) outcomes, and (iv) next states. States of offline reinforcement learning dataset 607 refer to environmental data 346 itself, such as one or more of time information, location information, cellular wireless communication information, Wi-Fi wireless communication information, calendar information, and external device information. Actions refers to UE device 338 responses to given set of environmental data 346. For example, an action may be that UE device 338 roamed from Wi-Fi wireless communication network 304 to cellular wireless communication network 302 in response to a given set of environmental data 346, or an action may be that UE device 338 did not roam from Wi-Fi wireless communication network 304 in response to a given set of environmental data 346. Each outcome represents whether a given action was successful. For example, a roaming action may be successful if UE device 338 did not lose connectivity in response to the roaming action, and a roaming action may be unsuccessful if UE device 338 did lose connectivity in response to the roaming action. A next state represents environmental data 346 after an action. For example, if an action consisted of UE device 338 roaming from Wi-Fi wireless communication network 304 to cellular wireless communication network 302, a next state may represent environmental data 346 collected by 340 after UE device 338 has roamed from Wi-Fi wireless communication network 304 to cellular wireless communication network 302.

Method 600 proceeds from block 606 to a block 608 where machine learning module 344 trains roaming model 342 based off-line reinforcement learning dataset 607, using an off-line reinforcement training technique known in the art. Method 600 subsequently proceeds from block 608 to a block 610 where machine learning module 344 sends roaming model 342 to UE device 338.

It should be noted that machine learning module 344 could use a combination of off-line reinforcement learning and on-line reinforcement learning to train roaming model 342. For example, machine learning module 344 may use an off-line method similar to that of method 600 to initially train roaming model 342, and machine learning module 344 may subsequently use an on-line reinforcement learning method similar to that of blocks 508-526 of method 500 to refine roaming model 342. Additionally, it should be noted that roaming model 342 may be updated from time-to-time after it has been completed, such as in response to a predetermined amount of time having elapsed or in response to a change in communication environment 300.

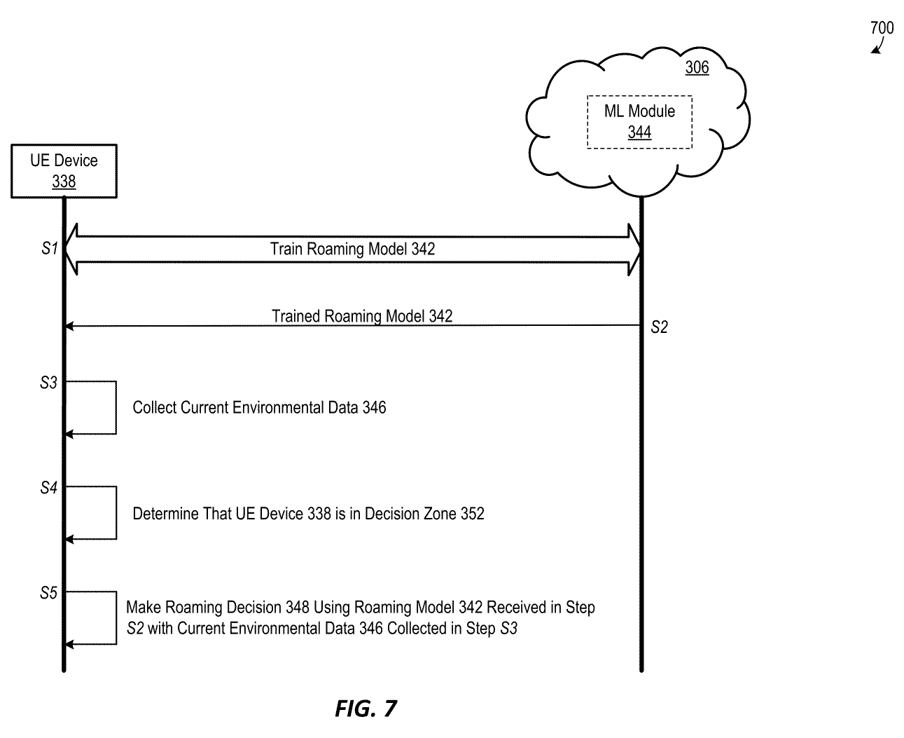

FIG. 7 is dataflow diagram 700 illustrating one example of operation of system 350 of FIG. 3. However, it is understood that system 350 of FIG. 3 is not limited to operating according to the example of dataflow diagram 700. FIG. 7 includes respective vertical lines logically representing each of UE device 338 and distributed computing environment 306. FIG. 7 does not illustrate communication infrastructure communicatively coupling UE device 338 with distributed computing environment 306, but it understood that UE device 338 and distributed computing environment 306 could be communicatively coupled, for example, by one or more of Wi-Fi wireless communication network 304, cellular wireless communication network 302, a communication service provider’s network, and the Internet. In a step S1, UE device 338 and machine learning module 344 cooperate to train roaming model 342. For example, in some embodiments, UE device 338 and machine learning module 344 cooperate to train roaming model 342 using on-line reinforcement learning, such as according to method 500 of FIGS. 5A and 5B. As another example, in some other embodiments, UE device 338 and machine learning module 344 cooperate to train roaming model 342 using off-line reinforcement learning, such as according to method 600 of FIG. 6. However, it is understood that UE device 338 and machine learning module 344 could cooperate to train roaming model 342 using another type of machine learning training. For example, UE device 338 and machine learning module 344 could cooperate to train roaming model 342 using supervised learning if desired roaming decisions are known in advance at the time of step S1.

In a step S2, machine learning module 344 sends roaming model 342 from distributed computing environment 306 to UE device 338 after machine learning module 344 has completed training roaming model 342. In a step S3, collection application 340 collects current environmental data 346, such as one or more of location information for UE device 338, cellular wireless communication information, Wi-Fi wireless communication information, time and date information, calendar information, user action information, and information from one or more devices external to UE device 338. In a step S4, UE device 338 determines that it is located within decision zone 352, such as in response to location information of current environmental data 346 collected in step S3 indicating that UE device 338 is within decision zone 352. In a step S5, UE device 338 uses roaming model 342 to make roaming decision 348 in response to determining in step S4 that UE device 338 is within decision zone 352. The roaming model 342 used in step S5 is the roaming model 342 received in step S2, and the current environmental data 346 collected in step S3 is used as input data to roaming model 342 in step S5.

The type of roaming decision made in step S5 may vary, for example, according to the configuration of roaming model 342. Discussed below are several example roaming decisions of step S5 discussed with respect to FIGS. 3 and 4. However, it is understood that roaming model 342 is not limited to the following example roaming decisions.

Example Roaming Decision A – Roam From Wi-Fi to Cellular. In this example, (i) UE device 338 is currently being served by access point 332, as depicted by a wireless link 354 in FIG. 3, (ii) roaming model 342 predicts that UE device 338 will likely exit building 402 of FIG. 4, and (iii) and roaming model 342 predicts that UE device 338 would be better served by cellular wireless communication network 302 than by Wi-Fi wireless communication network 304 after UE device 338 exits building 402. In response thereto, roaming model 342 may make a roaming decision specifying that UE device 338 roam from Wi-Fi wireless communication network 304 to cellular wireless communication network 302.

Example Roaming Decision B – Remain on Wi-Fi. In this example, (i) UE device 338 is currently being served by access point 332, as depicted by wireless link 354 in FIG. 3, (ii) roaming model 342 predicts that UE device 338 will likely remain within building 402 of FIG. 4, and (iii) and roaming model 342 predicts that UE device 338 would be better served by Wi-Fi wireless communication network 304 than by cellular wireless communication network 302 at UE device 338’s predicted future location within building 402. In response thereto, roaming model 342 may make a roaming decision specifying that UE device 338 does not roam, or stated differently, specifying that UE device 338 remains served by Wi-Fi wireless communication network 304.

Example Roaming Decision C – Remain on Cellular. In this example, (i) UE device 338 is currently being served by base station 314, as depicted by a wireless link 356 in FIG. 3, due to UE device 338 having been outside building 402 before UE device 338 entered decision zone 352, (ii) roaming model 342 predicts that UE device 338 will likely exit building 402 of FIG. 4, and (iii) and roaming model 342 predicts that UE device 338 would be better served by cellular wireless communication network 302 than by Wi-Fi wireless communication network 304 after UE device 338 exits building 402. In response thereto, roaming model 342 may make a roaming decision specifying that UE device 338 does not roam, or state differently, that UE device 338 remains served by cellular wireless communication network 302.

Example Roaming Decision D – Roam From Cellular to Wi-Fi. In this example, (i) UE device 338 is currently being served by base station 314, as depicted by a wireless link 356 in FIG. 3, due to UE device 338 having been outside building 402 before UE device 338 entered decision zone 352, (ii) roaming model 342 predicts that UE device 338 will likely remain within building 402 of FIG. 4, and (iii) and roaming model 342 predicts that UE device 338 would be better served by Wi-Fi wireless communication network 304 than by cellular wireless communication network 302 at UE device 338’s predicted future location within building 402. In response thereto, roaming model 342 may make a roaming decision specifying that UE device 338 roam from cellular wireless communication network 302 to Wi-Fi wireless communication network 304.

Example Roaming Decision E – Roam From One Access Point to Another Access Point. In this example, (i) UE device 338 is currently being served by access point 332, as depicted by wireless link 354 in FIG. 3, (ii) roaming model 342 predicts that UE device 338 will likely move to a location 418 (FIG. 4) in building 402 that is near access point 334, and (iii) and roaming model 342 predicts that UE device 338 would be better served by access point 334 than by access point 332 at predicted future location 418. In response thereto, roaming model 342 may make a roaming decision specifying that UE device 338 roam from access point 332 to access point 334.

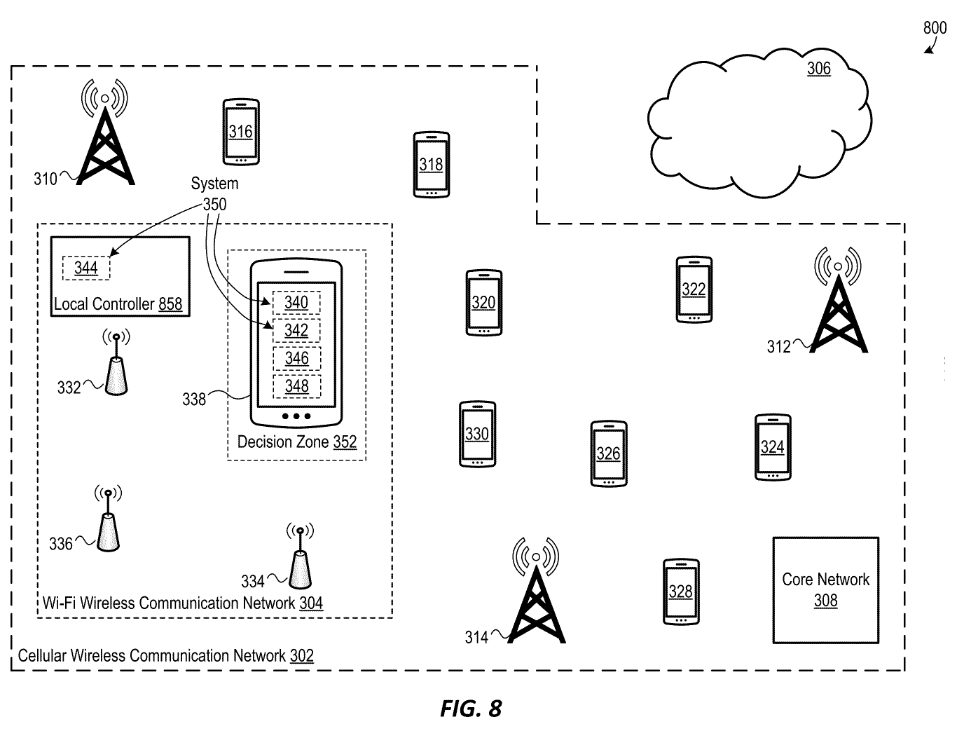

Referring again to FIG. 3, the fact that machine learning module 344 is hosted by distributed computing environment 306 advantageously helps minimize resource requirements of UE device 338. Additionally, the fact that roaming model 342 is hosted by UE device 338 helps minimize latency in roaming model 342 making roaming decisions as well as latency in UE device 338 implementing roaming decisions. However, the respective locations of elements of system 350 could vary, such as to realize different advantages than those offered by the configuration of FIG. 3. For example, discussed below with respect to FIGS. 8, 10, and 12 are several alternative locations of the elements of system 350. However, it is understood that additional alternative locations of the elements of system 350 are possible.

FIG. 8 is a schematic diagram of a communication environment 800, which is an alternate embodiment of communication environment 300 (FIG. 3) where (i) Wi-Fi wireless communication network 304 further includes a local controller 858 and (ii) machine learning module 344 is hosted by local controller 858 instead of by distributed computing environment 306. Consequently, system 350 spans UE device 338 and local controller 858 in communication environment 800. Local controller 858 is configured, for example, to control operation of Wi-Fi wireless communication network 304. In some embodiments, local controller 858 is a stand-alone element. In some other embodiments, local controller 858 is part of another element, such as a gateway or a modem, where the gateway or modem communicatively couple Wi-Fi wireless communication network 304 with a communication service provider’s network (not shown). Additionally, in some embodiments, one or more of access point 332, access point 334, and access point 336 are integrated with local controller 858. Furthermore, in some other alternate embodiments, local controller 858 is part of a local area network other than Wi-Fi wireless communication network 304.

Communication environment 800 operates in the same manner as communication environment 300 except that data flowing between UE device 338 and machine learning module 344 flows between UE device 338 and local controller 858, instead of between UE device 338 and distributed computing environment 306. As such, the configuration of communication environment 800 promotes user privacy by eliminating the need for data related to roaming model 342 to flow to distributed computing environment 306. However, local controller 858 may need significant processing capability to train roaming model 342.

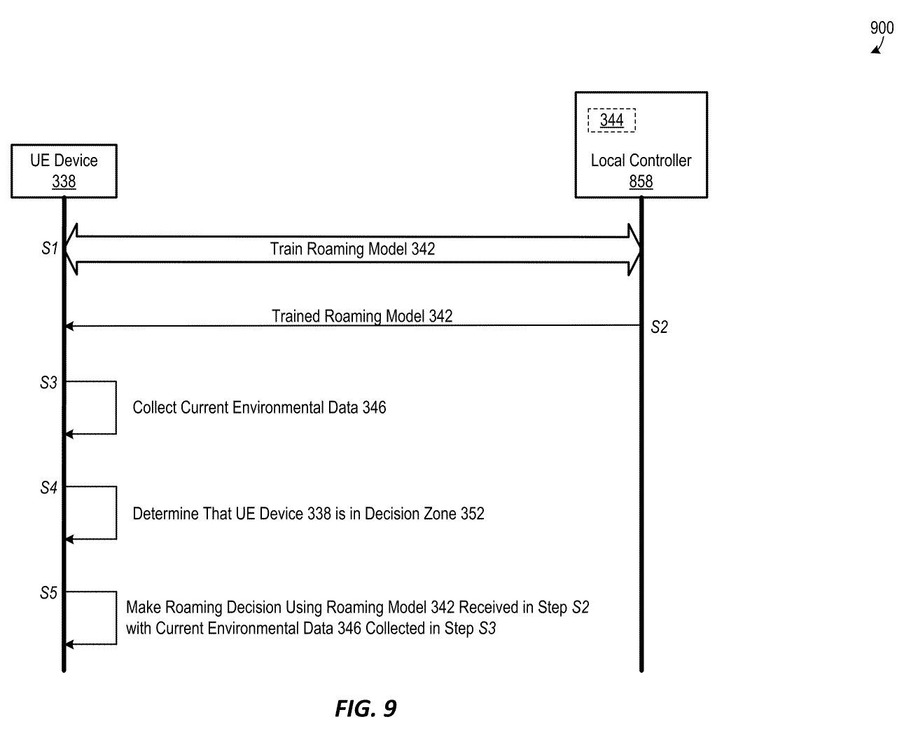

FIG. 9 is dataflow diagram 900 illustrating one example of operation of system 350 of FIG. 8. However, it is understood that system 350 of FIG. 8 is not limited to operating according to the example of dataflow diagram 900. FIG. 9 include respective vertical lines logically representing each of UE device 338 and local controller 858. FIG. 9 does not illustrate communication infrastructure communicatively coupling UE device 338 with local controller 858, but it understood that UE device 338 and local controller 858 could be communicatively coupled, for example, by one or more of Wi-Fi wireless communication network 304, cellular wireless communication network 302, a communication service provider’s network, and the Internet. In a step S1, UE device 338 and machine learning module 344 cooperate to train roaming model 342. For example, in some embodiments, UE device 338 and machine learning module 344 cooperate to train roaming model 342 using on-line reinforcement learning, such as according to method 500 of FIGS. 5A and 5B. As another example, in some other embodiments, UE device 338 and machine learning module 344 cooperate to train roaming model 342 using off-line reinforcement learning, such as according to method 600 of FIG. 6. However, it is understood that UE device 338 and machine learning module 344 could cooperate to train roaming model 342 using another type of machine learning training. For example, UE device 338 and machine learning module 344 could cooperate to train roaming model 342 using supervised learning if desired roaming decisions are known at the time of step S1.

In a step S2, machine learning module 344 sends roaming model 342 from local controller 858 to UE device 338 after machine learning module 344 has completed training roaming model 342. In a step S3, collection application 340 collects current environmental data 346, such as one or more of location information for UE device 338, cellular wireless communication information, Wi-Fi wireless communication information, time and date information, calendar information, user action information, and information from one or more devices external to UE device 338. In a step S4, UE device 338 determines that it is located within decision zone 352, such as in response to location information of current environmental data 346 collected in step S3 indicating that UE device 338 is within decision zone 352. In a step S5, UE device 338 uses roaming model 342 to make roaming decision 348 in response to determining in step S4 that UE device 338 is within decision zone 352. The roaming model 342 used in step S5 is the roaming model 342 received in step S2, and current environmental data 346 collected in step S3 is used as input data to roaming model 342. The type of roaming decision made in step S5 of FIG. 9 may vary, and in some embodiments, the roaming decision is analogous to one of the example roaming decisions discussed above with respect to FIG. 7.

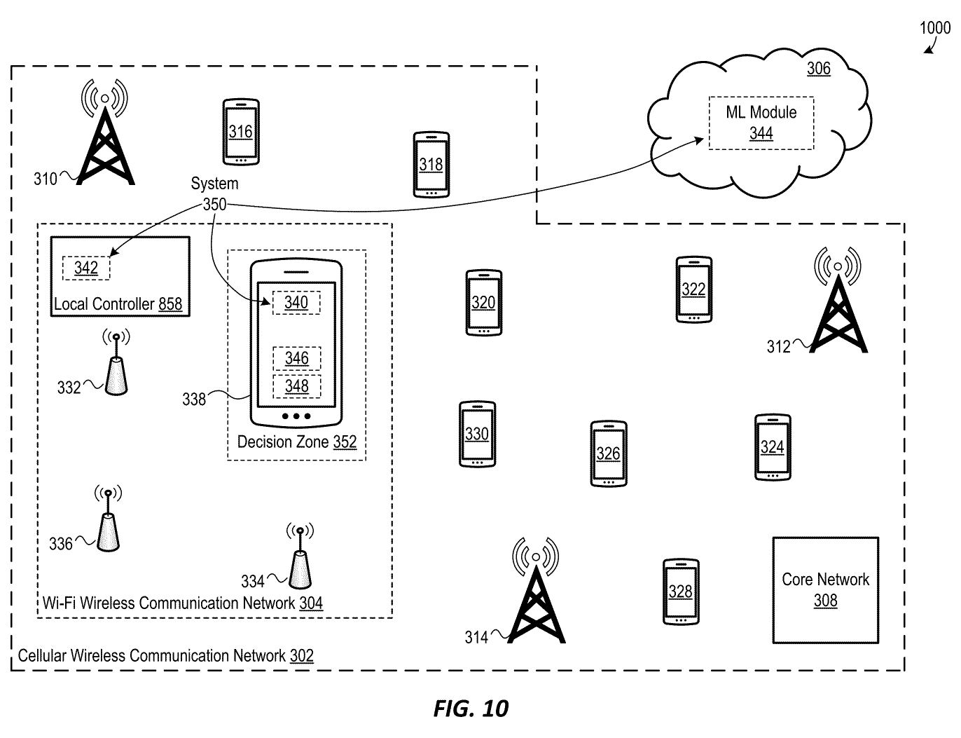

FIG. 10 is a schematic diagram of a communication environment 1000, which is an alternate embodiment of communication environment 300 (FIG. 3) where (i) Wi-Fi wireless communication network 304 further includes local controller 858 (discussed above with respect to FIG. 8) and (ii) roaming model 342 is hosted by local controller 858 instead of by UE device 338. Consequently, system 350 spans UE device 338, local controller 858, and distributed computing environment 306 in communication environment 800. Communication environment 1000 operates in the same manner as communication environment 300 except that local controller 858 is part of data flow of system 350 due to roaming model 342 being hosted by local controller 858. The configuration of communication environment 1000 helps minimize resource requirements of UE device 338 by moving roaming model 342 from UE device 338 to local controller 858. However, roaming decision 348 latency may increase due to the need for data associated with a roaming decision 348 to flow between UE device 338 and local controller 858.

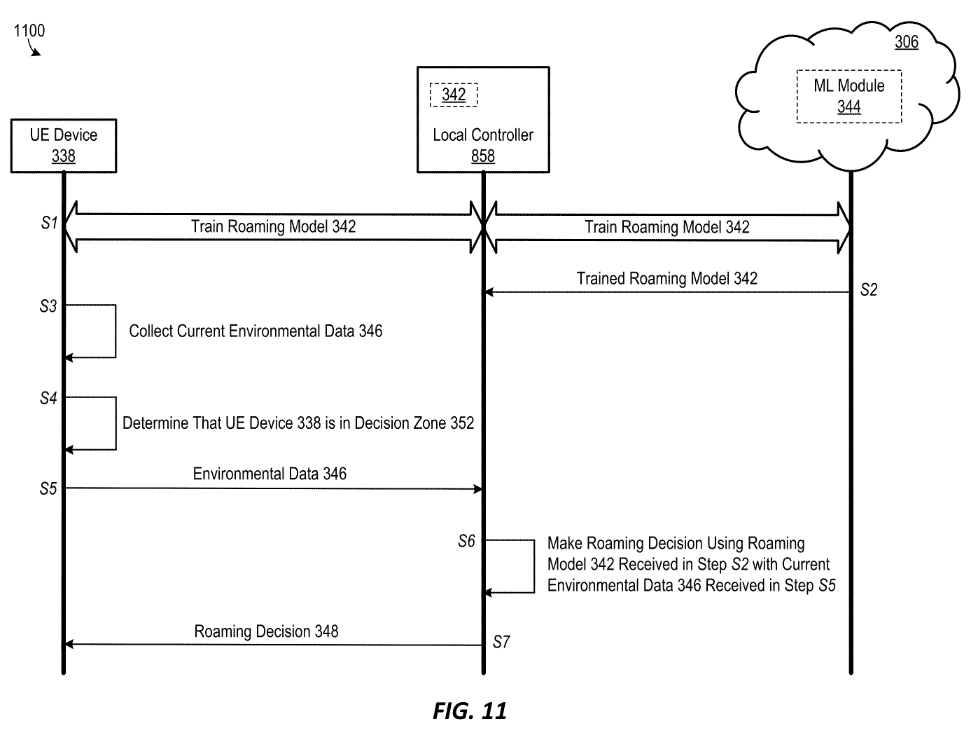

FIG. 11 is dataflow diagram 1100 illustrating one example of operation of system 350 of FIG. 10. However, it is understood that system 350 of FIG. 10 is not limited to operating according to the example of dataflow diagram 1100. FIG. 11 includes respective vertical lines logically representing each of UE device 338, local controller 858, and distributed computing environment 306. FIG. 11 does not illustrate communication infrastructure communicatively coupling UE device 338, local controller 858, and distributed computing environment 306, but it understood that UE device 338, local controller 858, and distributed computing environment 306 could be communicatively coupled, for example, by one or more of Wi-Fi wireless communication network 304, cellular wireless communication network 302, a communication service provider’s network, and the Internet. In a step S1, UE device 338, local controller 858, and machine learning module 344 cooperate to train roaming model 342. For example, in some embodiments, UE device 338, local controller 858, and machine learning module 344 cooperate to train roaming model 342 using on-line reinforcement learning, such as according to method 500 of FIGS. 5A and 5B with dataflow modifications to reflect that roaming model 342 has been moved from UE device 338 to local controller 858. As another example, in some other embodiments, UE device 338, local controller 858, and machine learning module 344 cooperate to train roaming model 342 using off-line reinforcement learning, such as according to method 600 of FIG. 6 with dataflow modifications to reflect that roaming model 342 has been moved from UE device 338 to local controller 858. However, it is understood that UE device 338, local controller 858, and machine learning module 344 could cooperate to train roaming model 342 using another type of machine learning training. For example, UE device 338, local controller 858, and machine learning module 344 could cooperate to train roaming model 342 using supervised learning if desired roaming decisions are known at the time of step S1.

In a step S2, machine learning module 344 sends roaming model 342 from distributed computing environment 306 to local controller 858 after machine learning module 344 has completed training roaming model 342. In a step S3, collection application 340 collects current environmental data 346, such as one or more of location information for UE device 338, cellular wireless communication information, Wi-Fi wireless communication information, time and date information, calendar information, user action information, and information from one or more devices external to UE device 338. In a step S4, UE device 338 determines that it is located within decision zone 352, such as in response to location information of current environmental data 346 collected in step S3 indicating that UE device 338 is within decision zone 352. In a step S5, UE device 338 sends current environmental data 346 collected in step S3 to local controller 858. In a step S6, local controller 858 uses roaming model 342 to make roaming decision 348 in response to UE device 338 determining in step S4 that UE device 338 is within decision zone 352. The roaming model 342 used in step S6 is the roaming model 342 received in step S2, and environmental data 346 sent in step S5 is used as input data to roaming model 342. In a step S7, local controller 858 sends roaming decision 348 to UE device 338. The type of roaming decision made in step S6 of FIG. 11 may vary, and in some embodiments, the roaming decision is analogous to one of the example roaming decisions discussed above with respect to FIG. 7.

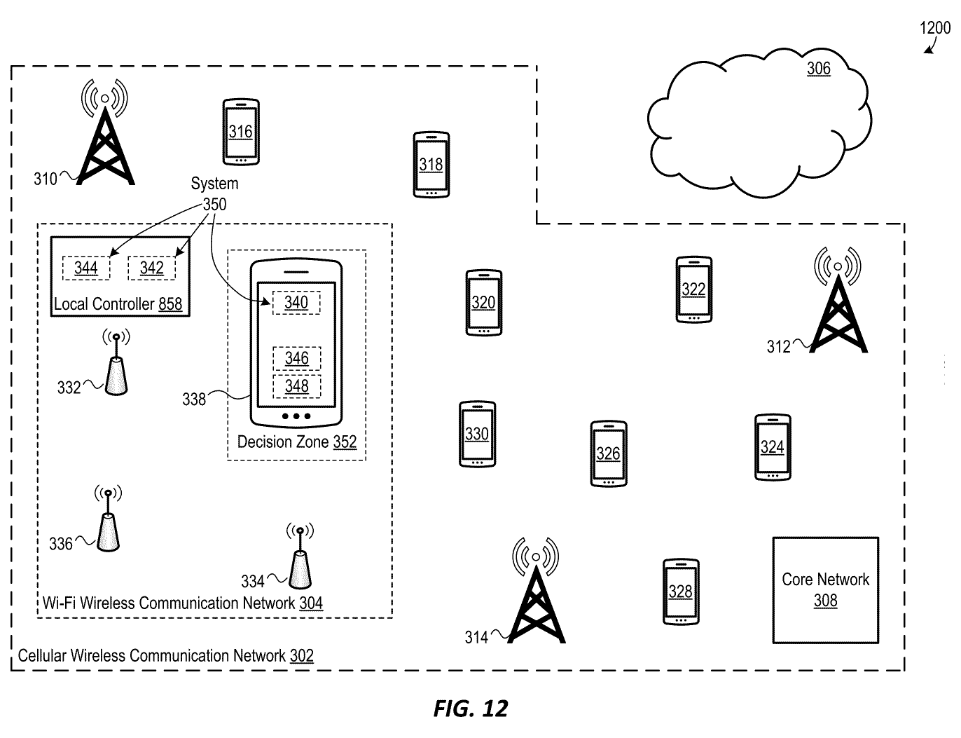

FIG. 12 is a schematic diagram of a communication environment 1200, which is an alternate embodiment of communication environment 300 (FIG. 3) where (i) Wi-Fi wireless communication network 304 further includes local controller 858 (discussed above with respect to FIG. 8), (ii) roaming model 342 is hosted by local controller 858 instead of by UE device 338, and machine learning module 344 is hosted by local controller 858 instead of by distributed computing environment 306. Consequently, system 350 spans UE device 338 and local controller 858 in communication environment 1200. Communication environment 1200 operates in the same manner as communication environment 300 except that data flows between UE device 338 and local controller 858, instead of between UE device 338 and distributed computing environment 306, due to each of roaming model 342 and machine learning module 344 being hosted by local controller 858. The configuration of communication environment 1200 promotes user privacy by eliminating the need for any data associated with system 350 to flow to distributed computing environment 306. Additionally, the configuration of communication environment 1200 helps minimize resource requirements of UE device 338 by moving roaming model 342 from UE device 338 to local controller 858. However, local controller 858 may need significant processing capability to train roaming model 342. Additionally, roaming decision 348 latency may increase due to the need for data associated with a roaming decision 348 to flow between UE device 338 and local controller 858

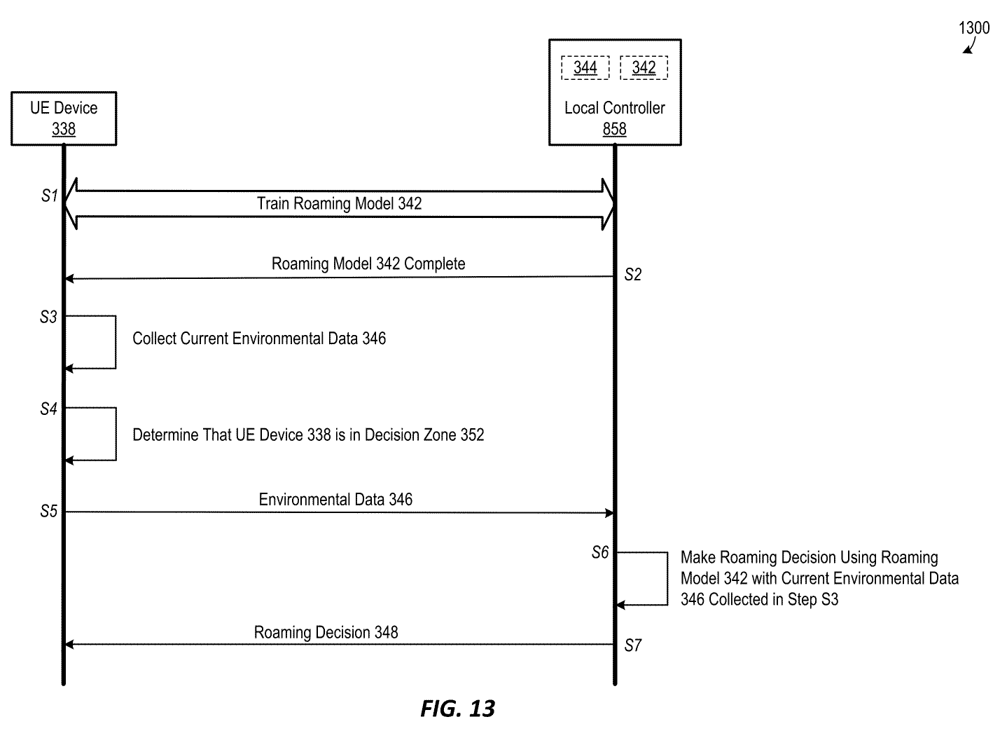

FIG. 13 is dataflow diagram 1300 illustrating one example of operation of system 350 of FIG. 12. However, it is understood that system 350 of FIG. 12 is not limited to operating according to the example of dataflow diagram 1300. FIG. 13 includes respective vertical lines logically representing each of UE device 338 and local controller 858. FIG. 13 does not illustrate communication infrastructure communicatively coupling UE device 338 with local controller 858, but it understood that UE device 338 and local controller 858 could be communicatively coupled, for example, by one or more of Wi-Fi wireless communication network 304, cellular wireless communication network 302, a communication service provider’s network, and the Internet. In a step S1, UE device 338 and machine learning module 344 cooperate to train roaming model 342. For example, in some embodiments, UE device 338 and machine learning module 344 cooperate to train roaming model 342 using on-line reinforcement learning, such as according to method 500 of FIGS. 5A and 5B. As another example, in some other embodiments, UE device 338 and machine learning module 344 cooperate to train roaming model 342 using off-line reinforcement learning, such as according to method 600 of FIG. 6. However, it is understood that UE device 338 and machine learning module 344 could cooperate to train roaming model 342 using another type of machine learning training. For example, UE device 338 and machine learning module 344 could cooperate to train roaming model 342 using supervised learning if desired roaming decisions are known at the time of step S1.

In a step S2, machine learning module 344 sends a message to UE device 338 advising that roaming model 342 is complete. In a step S3, collection application 340 collects current environmental data 346, such as one or more of location information for UE device 338, cellular wireless communication information, Wi-Fi wireless communication information, time and date information, calendar information, user action information, and information from one or more devices external to UE device 338. In a step S4, UE device 338 determines that it is located within decision zone 352, such as in response to location information of current environmental data 346 collected in step S3 indicating that UE device 338 is within decision zone 352. In a step S5, UE device 338 sends the current environmental data 346 collected in step S3 to local controller 858. In a step S6, local controller 858 uses roaming model 342 to make roaming decision 348 in response to UE device 338 determining in step S4 that UE device 338 is within decision zone 352. The environmental data 346 sent in step S5 is used as input data to roaming model 342. In a step S7, local controller 858 sends roaming decision 348 to UE device 338. The type of roaming decision made in step S5 of FIG. 13 may vary, and in some embodiments, the roaming decision is analogous to one of the example roaming decisions discussed above with respect to FIG. 7.

### Combinations of Features

Features described above may be combined in various ways without departing from the scope hereof. The following examples illustrate some possible combinations.

(A1) A method for seamless wireless connectivity operable by a user equipment (UE) device includes (i) receiving a roaming model from a machine learning module that is external to the UE device, the roaming model having been trained by the machine learning module at least partially using environmental data that was previously collected by the UE device, (ii) collecting current environmental data, (iii) determining that the UE device is within a decision zone at least partially based on the current environmental data, and (iv) in response to determining that the UE device is within the decision zone, using the roaming model with the current environmental data as an input to the roaming model to make a roaming decision.

(A2) In the method denoted as (A1), the roaming decision may include determining whether to roam from a Wi-Fi wireless communication network to a cellular wireless communication network.

(A3) In either one of the methods denoted as (A1) and (A2), the roaming decision may include determining whether to roam from one access point to another access point.

(A4) In any one of the methods denoted as (A1) through (A3), the current environmental data may include location information indicating a location of the UE device.

(A5) In any one of the methods denoted as (A1) through (A4), the current environmental data may include information on one or more wireless communication networks currently available to the UE device.

(A6) In any one of the methods denoted as (A1) through (A5), current environmental data may include information from one or more devices that are external to the UE device.

(A7) In any one of the methods denoted as (A1) through (A6), the current environmental data may include one or more of time information and date information.

(A8) In any one of the methods denoted as (A1) through (A7), the current environmental data may include calendar information.

(A9) In any one of the methods denoted as (A1) through (A8), the current environmental data may include user action information.

(A10) In any one of the methods denoted as (A1) through (A9), the machine learning module may be hosted by a distributed computing environment.

(A11) In any one of the methods denoted as (A1) through (A10), the machine learning module may be hosted by a local controller of a Wi-Fi wireless communication network.

(B1) A method for seamless wireless connectivity operable by a local controller of a Wi-Fi wireless communication network includes (i) receiving a roaming model from a machine learning module that is external to the local controller, the roaming model having been trained by the machine learning module at least partially using environmental data that was previously collected by a user equipment (UE) device, the UE device being a client of the Wi-Fi wireless communication network, (ii) receiving, from the UE device, current environmental data, (iii) using the roaming model with the current environmental data as an input to the roaming model to make a roaming decision, and (iv) sending the roaming decision to the UE device.

(B2) In the method denoted as (B1), the roaming decision may include determining whether to roam from the Wi-Fi wireless communication network to a cellular wireless communication network.

(B3) In either one of the methods denoted as (B1) and (B2), the roaming decision may include determining whether to roam from one access point of the Wi-Fi wireless communication network to another access point of the Wi-Fi wireless communication network.

(B4) In any one of the methods denoted as (B1) through (B3), the current environmental data may include one or more of (i) information indicating a location of the UE device, (ii) information on one or more wireless communication networks currently available for use by the UE device, (iii) information from one or more devices that are external to the UE device, (iv) time information, (v) date information, (vi) calendar information, and (vii) user action information.

(C1) A method for seamless wireless connectivity operable by a local controller of a Wi-Fi wireless communication network includes (i) cooperating with a user equipment (UE) device to train a roaming model, the UE device being a client of the Wi-Fi wireless communication network, (ii) receiving, from the UE device, current environmental data, (iii) using the roaming model with the current environmental data as an input to the roaming model to make a roaming decision, and (iv) sending the roaming decision to the UE device.

(C2) In the method denoted as (C1), the roaming decision may include one of (i) determining whether to roam from the Wi-Fi wireless communication network to a cellular wireless communication network and (ii) determining whether to roam from one access point of the Wi-Fi wireless communication network to another access point of the Wi-Fi wireless communication network.

(C3) In either one of the methods denoted as (C1) and (C2), the current environmental data may include one or more of (i) information indicating a location of the UE device, (ii) information on one or more wireless communication networks currently available for use by the UE device, (iii) information from one or more devices that are external to the UE device, (iv) time information, (v) date information, (vi) calendar information, and (vii) user action information.

(C4) In any one of the methods denoted as (C1) through (C3), cooperating with the UE device to train the roaming model may include using on-line reinforcement learning to update the roaming model based on one or more roaming decision outcomes received from the UE device.

(C5) In any one of the methods denoted as (C1) through (C4), cooperating with the UE device to train the roaming model may include (i) generating an off-line reinforcement learning dataset using environmental data previously received from the UE device and (ii) training the roaming model based on the off-line reinforcement learning dataset.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for seamless wireless connectivity operable by a user equipment (UE) device, the method comprising:
receiving a roaming model from a machine learning module that is external to the UE device, the roaming model having been trained by the machine learning module at least partially using environmental data that was previously collected by the UE device;
collecting current environmental data;
determining that the UE device is within a decision zone at least partially based on the current environmental data; and
in response to determining that the UE device is within the decision zone, using the roaming model with the current environmental data as an input to the roaming model to make a roaming decision.

2. The method of claim 1, wherein the roaming decision comprises determining whether to roam from a Wi-Fi wireless communication network to a cellular wireless communication network.

3. The method of claim 1, wherein the roaming decision comprises determining whether to roam from one access point to another access point.

4. The method of claim 1, wherein the current environmental data includes location information indicating a location of the UE device.

5. The method of claim 1, wherein the current environmental data comprises information on one or more wireless communication networks currently available to the UE device.

6. The method of claim 1, wherein the current environmental data comprises information from one or more devices that are external to the UE device.

7. The method of claim 1, wherein the current environmental data comprises one or more of time information and date information.

8. The method of claim 1, wherein the current environmental data comprises calendar information.

9. The method of claim 1, wherein the current environmental data comprises user action information.

10. The method of claim 1, wherein the machine learning module is hosted by a distributed computing environment.

11. The method of claim 1, wherein the machine learning module is hosted by a local controller of a Wi-Fi wireless communication network.

12. A method for seamless wireless connectivity operable by a local controller of a Wi-Fi wireless communication network, the method comprising:
receiving a roaming model from a machine learning module that is external to the local controller, the roaming model having been trained by the machine learning module at least partially using environmental data that was previously collected by a user equipment (UE) device, the UE device being a client of the Wi-Fi wireless communication network;
receiving, from the UE device, current environmental data;
using the roaming model with the current environmental data as an input to the roaming model to make a roaming decision; and
sending the roaming decision to the UE device.

13. The method of claim 12, wherein the roaming decision comprises determining whether to roam from the Wi-Fi wireless communication network to a cellular wireless communication network.

14. The method of claim 12, wherein the roaming decision comprises determining whether to roam from one access point of the Wi-Fi wireless communication network to another access point of the Wi-Fi wireless communication network.

15. The method of claim 12, wherein the current environmental data includes one or more of (i) information indicating a location of the UE device, (ii) information on one or more wireless communication networks currently available for use by the UE device, (iii) information from one or more devices that are external to the UE device, (iv) time information, (v) date information, (vi) calendar information, and (vii) user action information.

16. A method for seamless wireless connectivity operable by a local controller of a Wi-Fi wireless communication network, the method comprising:
cooperating with a user equipment (UE) device to train a roaming model, the UE device being a client of the Wi-Fi wireless communication network;
receiving, from the UE device, current environmental data;
using the roaming model with the current environmental data as an input to the roaming model to make a roaming decision; and
sending the roaming decision to the UE device.

17. The method of claim 16, wherein the roaming decision comprises one of (i) determining whether to roam from the Wi-Fi wireless communication network to a cellular wireless communication network and (ii) determining whether to roam from one access point of the Wi-Fi wireless communication network to another access point of the Wi-Fi wireless communication network.

18. The method of claim 16, wherein the current environmental data includes one or more of (i) information indicating a location of the UE device, (ii) information on one or more wireless communication networks currently available for use by the UE device, (iii) information from one or more devices that are external to the UE device, (iv) time information, (v) date information, (vi) calendar information, and (vii) user action information.

19. The method of claim 16, wherein cooperating with the UE device to train the roaming model comprises using on-line reinforcement learning to update the roaming model based on one or more roaming decision outcomes received from the UE device.

20. The method of claim 16, wherein cooperating with the UE device to train the roaming model comprises:
generating an off-line reinforcement learning dataset using environmental data previously received from the UE device; and
training the roaming model based on the off-line reinforcement learning dataset.
